(19) United States
(12) Patent Application Publication
(10) Pub. No.: US 2009/0271425 A1
(43) Pub. Date: Oct. 29, 2009

(54) FORMATTED INTELLECTUAL PROPERTY DATA EXCHANGE OVER A NETWORK

(76) Inventors: Jean-Christophe Le Gall, Beacon Hill (AU); Maria Luchtmeijer, Baulkham Hills (AU)

Correspondence Address: COMPUTER PATENT ANNUITIES NORTH AMERICA, LLC;C/O CPA GLOBAL, P.O. BOX 52050, MINNEAPOLIS, MN, 55402, US

(21) Appl. No.: 12/332,258

(22) Filed: Dec. 10, 2008

Related U.S. Application Data
(60) Provisional application No. 60/996,870, filed on Dec. 10, 2007.

(51) Int. Cl. G06F 17/30; G06F 7/00

(52) U.S. Cl. 707/101; 707/100; 707/10; 707/E17.127; 707/E17.032

(57) ABSTRACT

A system, method and article of formatted information and data exchange that extends and replaces certain protocols for intellectual property data exchange using extensible markup language (XML) over a network is disclosed. Information and data is converted and transmitted between various applications and databases using flexible XDS schema fields designed specifically for a more efficient transfer of intellectual property-related data and information.

### FIELD OF THE INVENTION

The present invention relates to a system and method of formatted information and data exchange using extensible markup language protocols (XML) over a network such as a packet-switched network. More specifically, the preferred and alternative embodiments transmit information and data between various applications and databases that are used for managing, filing, and registering intellectual property such as patents, using flesible XDS schema fields designed for efficient transfer of intellectual property-related information.

### BACKGROUND OF THE INVENTION

In recent years patent and trademark offices (“PTO's”) around the world have been working towards harmonization of the processing of patent related information by forming and implementing standards of information and data exchange. In that regard, open protocol standards have been implemented by the World Industrial Property Organization (“WIPO”), such as ST. 36, “Recommendation for the Processing of Patent Information Using XML (Extensible Markup Language). ST.36 is an application of the Internet standard for XML found at www.w3c.org:
The Extensible Markup Language (XML) is a subset of SGML that is completely described in this document. It goal is to enable generic SGML to be served, received, and processed on the Web in the way that is not possible with HTML. XML has been designed for ease of implementation and for interoperability with both SGML and HTML.

ST.36 recommends using its version of XML applied to resources for filing, processing, publication, and exchange of “all types of patent information” according to the Handbook of Industrial Property Information and Documentation, Standard ST.36, ver. 1.2 (23 Nov. 2007). The WIPO handbook reports that ST.36 is based in large part on “Patent Cooperation Treaty, Administrative Instructions, Part 7, Annex F. Appendix I.” The purpose of ST. 36 “is to provide logical, system-independent structures for patent document processing, whether for text or image data.” The standard provides protocols for text of patent documents recorded as character coded data, whole pages of documents as images, and data within full-text documents that cannot be recorded as character coded data such as drawings, formulas, and some complex tables.

Another intellectual property protocol is used to exchange and communicate trademark information. The trademark extensible markup language (“TM-XML”) is used within industry, users, and governmental industrial property offices as an open standard for the exchange and processing of trademark documents and transaction records using XML. It was defined in June, 2003 by the Office of Harmonization in the Internal Market, and final version 1.0 was the basis for WIPO standard ST.66, “Recommendation for the Processing of Trademark Informatin using XML (Extensible Markup Language).” The ST.66 standard states that it is “ . . . aimed at providing guidance to national, regional and international authorities who, on the basis of national industrial property laws or international industrial property conventions, publish announcements, either on trademark applications or on registrations of trademarks.”

In the management of large volumes of patents and trademarks and the services related to procuring and maintaining those rights, large amounts of specialized data is retained in databases and transferred between various entities. For example, a corporation may use an intellectual property (“IP”) management software application to track and maintain its various patents and patent applications around the world. Data from this application could be exchanged with another IP management application that is used by an external legal service provider handling filing and docketing of patents and trademarks. Data could also be exchanged with various law firms handling the corporation's patent and trademark matters. Data could further be exchanged with an external legal service provider handling the payment of maintenance fees on the company's patents and trademarks around the world. A problem with such a network of applications and service providers is that each application or provider uses its own data from a specially formatted database making standardized data transfer between the various applications impossible.

Although ST.36 and TM-XML/ST.66 have improved communications between applicants and patent offices, it has been demonstrated as inadequate for a means of information transfer and management relating to procurement and maintenance of intellectual property by businesses and legal service providers. For example, a company owning thousands of patents may use one type of IP management application in-house, but its outside legal counsel and legal services outsourcing providers may each use different IP management software which have different formats and protocols to store and transfer the data. In one example, three different IP databases are created and maintained: one by the company that is the owner of the patents, one by legal counsel at a law firm, and one by the legal services outsourcing provider. Each such IP database has requirements for patent and trademark data processing and transfer that are different than those available in ST. 36 and TM-XML. Further, each such database is typically formatted and processed differently thus preventing integration and seamless information transfer with another database and preventing the transfer of critical, specialized information in a standard way. Duplicate databases for information such as patent prosecution, docketing and processing, document attachments, and annuity fee payments are created.

What is needed is a consistent set of rules and protocols that modify and extend XML intellectual property information transfer standards in order to turn duplicative and un-integrated specialized data and information needs of intellectual property management into a single standardized protocol of intellectual property data exchange.

### SUMMARY OF THE INVENTION

The preferred and alternative embodiments of the present invention provide a system and method for novel extensions and modifications of the open standards ST.36 XML for patent-related information and TM-XML for trademark-related information as a single protocol for transfer of intellectual property data between various specialized IP management software applications and servers, legal service providers, and patent offices.

### BRIEF DESCRIPTION OF THE DRAWINGS

For a better understanding of the nature of the present invention, its features and advantages, the subsequent detailed description is presented in connection with accompanying drawings in which:

FIG. 1 is a network system that is capable of implementing the exemplary embodiments;

FIG. 2 is a functional network system diagram of the preferred and alternative embodiments;

FIG. 3 is a functional diagram of the exemplary protocol engine of the embodiments;

FIG. 4A is a high-level flowchart of a method of incoming data for an exemplary protocol engine;

FIG. 4B is a high-level flowchart of a method of outgoing data for an exemplary protocol engine;

FIG. 5 is a block of computer components illustrating placement of the preferred protocol process module and IP application as tools in a computer system;

FIG. 6 illustrates definitions of the exemplary flexible XSD schema of the embodiments;

FIGS. 7A and 7B are diagrams of transaction components of the CPA-XML schema;

FIGS. 8A, 8B, and 8C are diagrams of case components of the CPA-XML schema;

FIG. 9 is a diagram of document components of the CPA-XML schema;

FIG. 10 is a diagram of payment components of the CPA-XML schema;

FIGS. 11A, 11B, and 11C are diagrams of address book components of the CPA-XML schema.

### DETAILED DESCRIPTION OF THE INVENTION

There is described herein preferred and exemplary embodiments for a system and method for data and information transfer between intellectual property-related applications and databases using extensible markup language (“XML”) over a packet-switched, broadband, or other network. The invention extends XML standards to include protocols for data transmission between applications and databases that relate to intellectual property management. The new protocol standard is

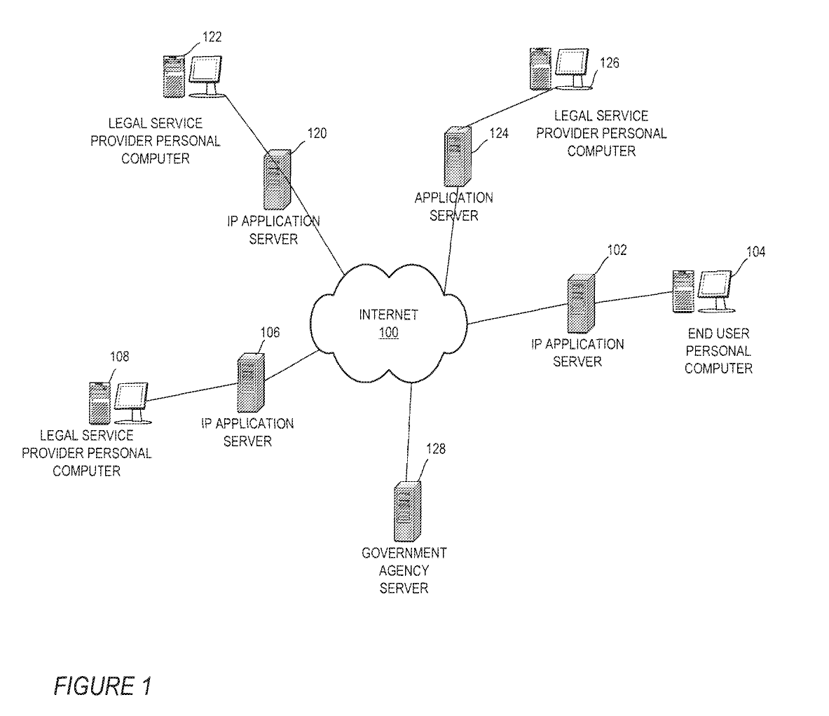

Referring to FIG. 1, a computer network system capable of implementing the preferred and alternative embodiments is illustrated. Users and servers connect to a broadband network, such as the public Internet 100, managed network lines, and/or a private wide area networks (WAN). Each server and end-user can connect to the Internet 100 through a high-speed network connection such as Ethernet LAN, cable modem, DSL (“Digital Subscriber Line”) or T1/T5 line.

A first specialized application server 102 handles and executes a first intellectual property (IP) management database application accessed by end user 104 that can include a patent holder corporation or administrator. A second specialized application server 116 handles and executes a second intellectual property (IP) management database application accessed by end user 118 which includes a legal outsource service provider. A third specialized application server 120 handles and executes a third intellectual property (IP) management database application accessed by end user 122 which includes a legal outsource service provider. A specialized server 124 operated by legal service provider 126, such as an intellectual property law firm, where IP attorneys and staff may store and transfer IP-related data. Specialized governmental agency server 128 is operated by a national or regional patent office as a registry of intellectual property rights.

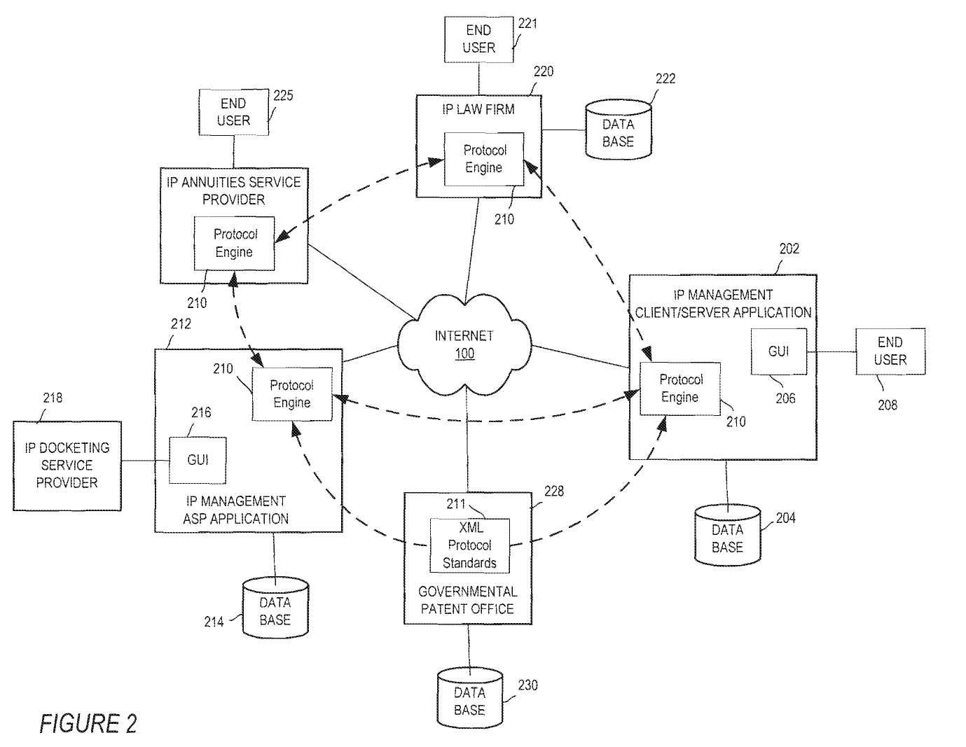

FIG. 2 is a functional network diagram illustrating various applications, specialized servers and computers, and end users transferring IP-related data using the data transfer language and protocols of the preferred embodiment. In the preferred embodiment, standardized XML using ST.36 protocols and TM-XML protocols are extended, and in some cases replaced, with the preferred embodiment of “CPA-XML,” (“Extendable Markup Language-Computer Patent Annuities”). Unlike prior art uses of SGML (“Standard Generalized Markup Language”), and its subset XML, for standard and specialized communications of patent and trademark-related documents and data, the present invention's use of the preferred markup language CPA-XML is a universal language that is specifically designed for use by a patent holder's IP management docketing application software, an IP legal services outsourcing firm and related IP docketing software, outside counsel patent and litigation firms, and outsourced legal services companies managing patent and trademark maintenance fees. As stated previously, many large entity IP application users have a need to eliminate duplicate data entries among IP application databases, outside IP counsel, and outsourced legal services companies. Existing SGML and XML protocols and standards in the prior art all lack the necessary fields and universal communication capabilities to properly execute such an exchange of data between the various in-house and outside applications and databases.

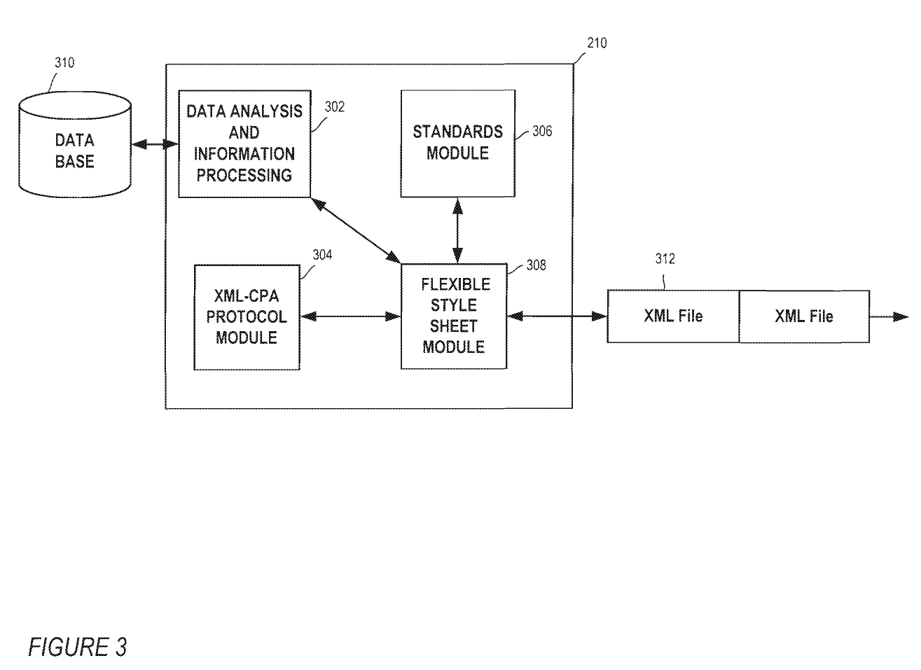

Referring to FIG. 2, specialized IP management application 202 is an exemplary client/server application that allows a company to manage IP rights. IP application 202 resides on server 12 or alternatively operationally function through server 12. IP application 204 provides for storing data associated with patent, trademark, domain name, and copyright portfolios in database 204. For purposes of the preferred embodiment, exemplary procedures for data relating to patent applications will be described, however one skilled in the art will recognize the system and methods of the preferred and exemplary embodiments can apply to any other type of intellectual property. IP application 202 manages submission of a patent application, prosecution and renewals docketing, information about third-party patents, entry and review of invention submissions, specialized inventor remuneration rules, inventor awards, designs, trademarks, Internet domain names, licenses and agreements, and cost tracking and forecasts. The specialized IP-related data for application 202 is stored in database 204 which could be any style of database capable of holding the data such as a relational database. GUI (“Graphical User Interface”) module 206 provides end user 208 a windows-type operational access to application 202 through personal computer 14. IP application 202 further comprises CPA-XML protocol module 210, which is described in greater detail in FIG. 3. CPA-XML protocol module 210 allows application 202 to communicate using the embodiment of XML protocol standards with other applications and service providers in a universal communications language via Internet 100, such as IP Management ASP application 212.

Specialized IP Management ASP application 212 is an enterprise Web-based ASP (“Application Service Provider”) application that dockets, assigns, and manages the lifecycle of patents, designs, copyrights, domains, and trademarks including the prosecution and lifecycle process. ASP IP application 212 resides on application server 16 or alternatively operationally functions through application server 12. Application 212 accesses IP data and associated information to relational database 214 in a format appropriate to its designed architecture. End user 218 may be an IP docketing and outsourced paralegal service provider 218 that accesses application 212 on personal computer 18 through GUI interface 216. ASP IP application comprises a version of exemplary CPA-XML protocol module 210 that allows application 202 to communicate with other applications and service providers' applications using the embodiment of XML protocol standards in a universal communications language via Internet 100.

IP law firm application 220 is an exemplary application software that accesses its own IP data in database 222 and may operationally reside on application server 24. End users 221 managing law firm application 220 via personal computer 26 perform legal work for the patent holder and communication IP related data with IP application 202 using protocols from the exemplary IP CPA-XML protocol module 200. For example, IP law firm application 220 may communicate with an IP annuities server provider application 224 to pay maintenance fees on patents and trademarks for law firm clients. IP Annuities application resides operationally on application server 20 and is accessed by end user 225 on personal computer 22. Application 224 accesses IP data in database 226 that is typically held in different formats than databases 204, 222, and 218. However application 224 can communicate IP related data with law firm application 220, application 202, and ASP application 212 using the preferred protocols of the CPA-XML protocol module 210 as part of its functionality. CPA-XML protocol module 210 is illustrated as functionality residing within each application of the network, however as one skilled in the art recognizes this functionality could reside anywhere in network 200 and could be accessed remotely by any of the applications on the network.

Governmental patent and trademark office application 228 is an exemplary application that accesses its own IP data in database 230 and may operationally reside on application server 28. Agency application 228 uses communication and data standards known in the industry such as WIPO standards ST 32, ST.33, and ST.36. Due to the specialized CPA-XML protocols, agency application 228 does not communicate directly with protocol module 210, however protocol module 210 has the capability of receiving data 230 that is transferred from agency application 228 and converting the data into CPA-XML protocols. One advantage of the present invention is that CPA-XML protocols does not prevent IP application 202 or IP ASP application 212 from communicating directly with agency application 228 using the agency's standard XML protocols via Internet 100 for purposes such as filing an application or filing a response to an office action.

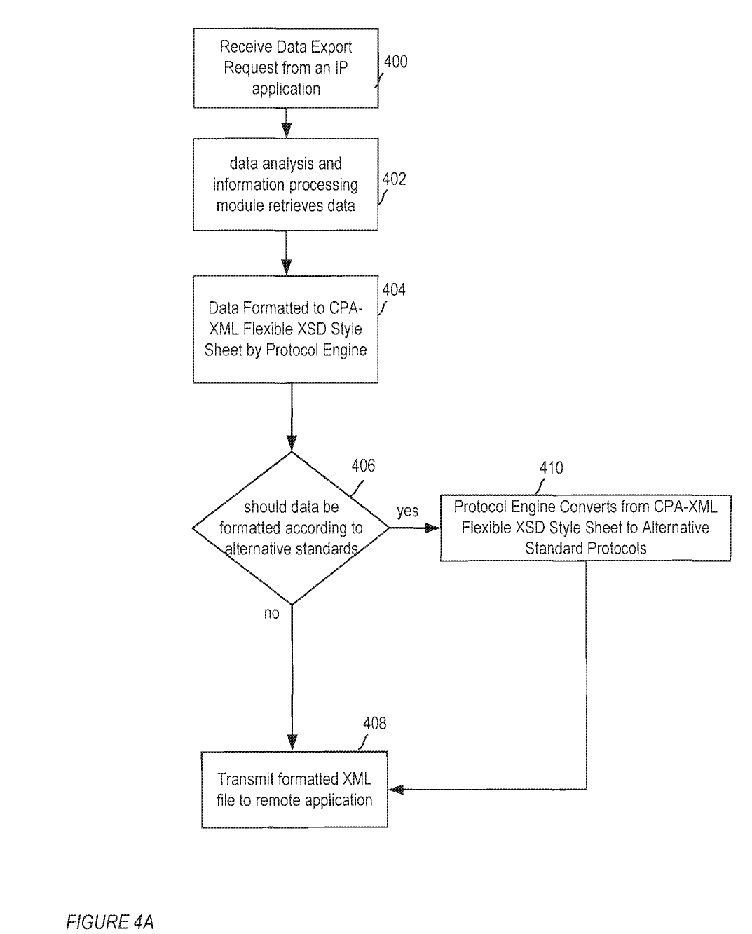

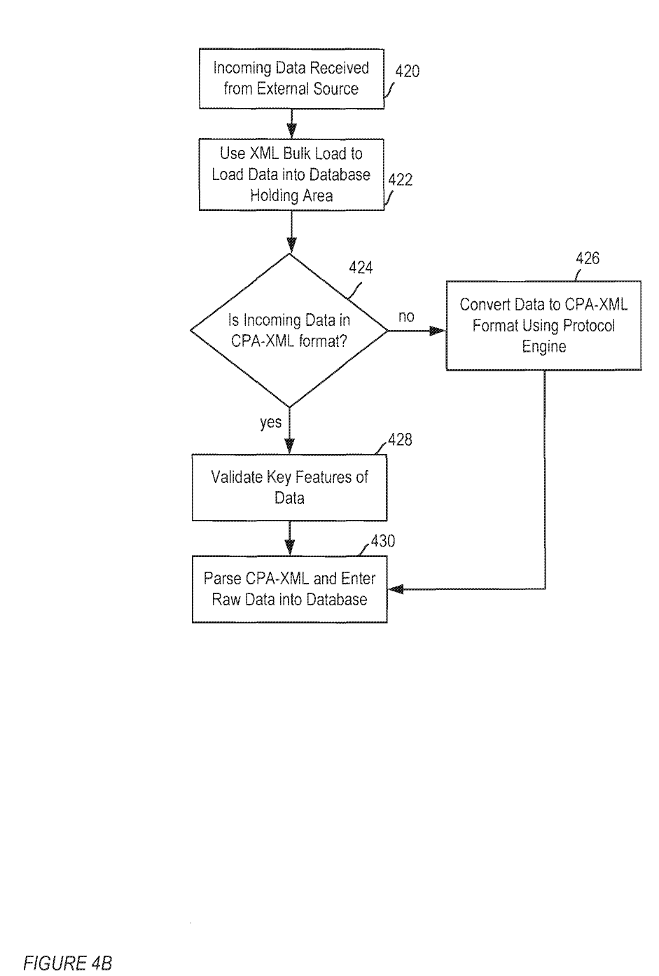

FIG. 3 illustrates the preferred embodiment for an exemplary protocol engine 210 of the CPA-XML flexible protocol. FIG. 4A is a flowchart illustrated the steps for exporting data out of protocol engine using a flexible XSD schema of the preferred embodiment. The engine 210 comprises a flexible XSD style sheet module 308, protocol module 304, data analysis and information processing module 302, and alternatively XML protocol standards module 306. CPA-XML Protocol engine 308 controls processing of data between exemplary IP database 310 and an external IP application via external network communication line.

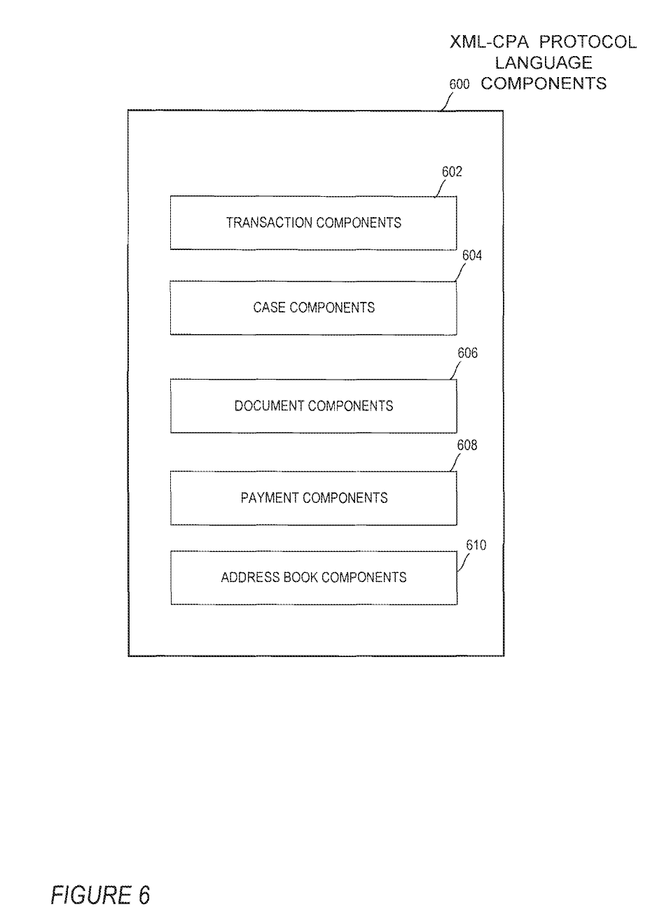

When a request from exemplary IP application 202 is made 400, data analysis and information processing module 302 retrieves data 402 from base 310 which is then analyzed by protocol engine 308. Engine 210 formats data 404 according to the preferred embodiment of a flexible XSD (“XML schema definition”) schema, as described in FIGS. 6-11, using module 308 according to the definitions of the embodiments listed herein. Engine 210 then analyzes data 406 to determine whether it should be formatted according to any alternative standards held in module 306. If not, module 308 formats the appropriate XSD 408 to the data 310 which can then be transmitted to a remote application operating under CPA-XML protocols. A generic XSD is a structure for the document or data that is represented through the schema. In the present invention, XSD is a more efficient structure than using prior technology such as Document Type Definitions (“DTD's”).

Alternatively, if IP data 310 should be formatted with markup protocols from a standard, such as ST.32, then engine 210 analyzes data according to standard markup protocols based on protocol information in standards module 306 and converts from CPA-XML 410 into an XML format that can then be transmitted to and received by the remote application. IP data 310 is then packetized into XML files for transmission. Each file 312 is divided into multiple content sections containing bytes of information.

FIG. 4B is a high level flowchart illustrating the method of receiving data by protocol engine 210. Incoming XML files containing IP data from a remote application are received into process module 420 and analyzed. The application XML bulk load is used 422 to then load the incoming XML data into a Database holding area. The Engine 210 then determines if the incoming data has been received in CPA-XML format? If not, the data is converted into CPA-XML schemas using the protocol engine 210. If the data is in the proper CPA-XML format, the data is validated 428 by checking certain key features of the incoming data. One the data has either been validated 428, or converted, 426, then the XML file is parsed and the raw data is entered 430 into a database 310.

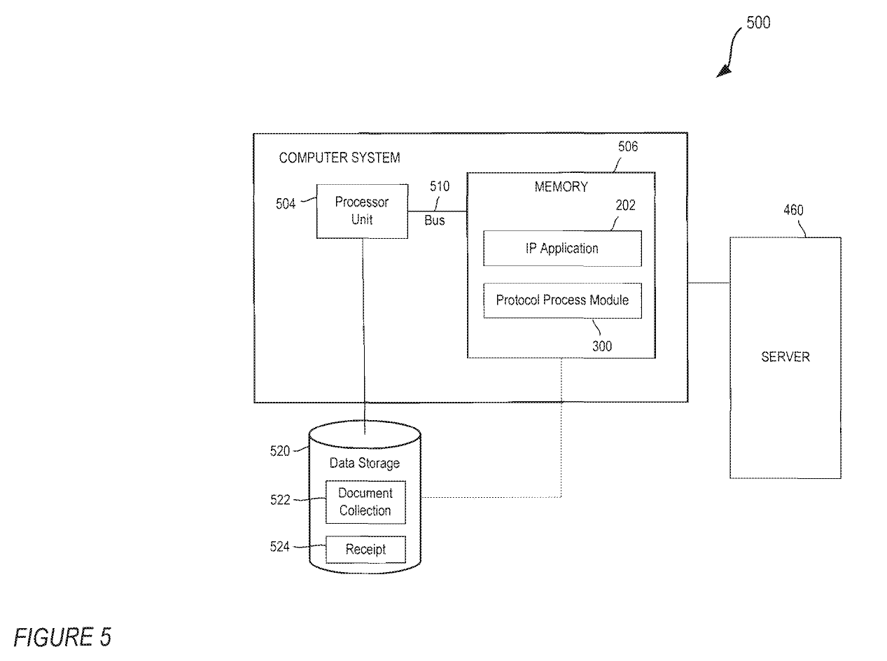

FIG. 5 is a block diagram 500 illustrating placement of an exemplary IP manager application, such as application 202, and CPA-XML protocol process module 300 as hardware tools in a computer system. The diagram shows a computer system 502 with a processor unit (504) coupled to memory 506 by a bus structure 510. Although only one processor unit 504 is shown, in one embodiment, the computer system 502 may include more processor units in an expanded design. The computer system includes data storage 520 in communication with the processor unit 504. The data storage unit is employed for retention of a collection of documents 522. In one embodiment, the collection of documents is patent application documents.

A request manager 530 is provided in communication with the system 502. However, in one embodiment, the request manager may be on a remote system (not shown) that is in communication with the system 502 across a network. The request manager 530 monitors submission deadlines associated with the collection patent application documents 522 retained on the data storage 520 in communication with the system 502. Upon detection of a deadline, also known as a due date, the request manager generates a message and communicates the message to an integration manager 540. As with the request manager, the integration manager may be local to the system 502 or on a remote system (not shown) that is in communication with the system 502 across a network. The integration manager 540 is also in communication with the collection of documents 522 retained on the data storage 520. More specifically, the integration manager 540 is responsible for loading the document(s) subject to the submission deadline, extracting the customer number, digital certificate, and password associated with the subject document(s), and properly attaching them to the patent submission application on a remote server 560. The system 502 is in communication with the remote server 560 across a network connection.

Following a successful submission of a document to the patent submission application on the remote server 560), a receipt 524 is generated. The receipt 562 is an electronic document which represents a physical/tangible document verifying receipt of submission of the subject document(s) to the patent submission application. In one embodiment, the generated receipt is return to the system 502 in response to completion of the document submission process. The generated receipt is demonstrative of the valid submission of the compiled patent documents to the patent submission application.

As shown herein, the request manager 530 and the integration manager (540) each reside in memory 506 local to the computer system 502. In one embodiment, each of the managers 530 and 540 may reside as hardware tools external to local memory 506, or may be implemented as a combination of hardware and software. Similarly, in one embodiment, the managers 530 and 540 may be combined into a single functional item that incorporates the functionality of the separate items. Furthermore, as shown herein each of the managers 530 and 540 are local to the computer system 502. However, in one embodiment they may be collectively or individually distributed across a network and function as a unit to support automated submission of patent documents. Accordingly, the managers 530 and 540 may be implemented as software tools, hardware tools, or a combination of software and hardware tools.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-useable or computer-readable medium providing program code for use by or in connection with a computer or any instruction execution system.

Reference is made to FIG. 6, where CPA-XML XSD definitions are illustrated. In practice, tag naming for each element in the CPA-XML schema is based on the ISO 11179 Part 5 (Name and Identification principles) without a separator between the name parts. In some definitions, examples are shown of the actual tag name. However, for purposes of description of the preferred and alternative embodiments, a space separator has been added between the name parts. In use, the components may be communicated partially, completely, or separately, depending on circumstances of the IP data requests. These components, while composed in a markup language, extends the XML format, such as TM-XML, such that complete compatibility with standards-driven XML, traditional XML, or TM-XML is not possible. Thus, an application using CPA-XML is only compatible to communicate IP data to another application using CPA-XML, however CPA-XML can receive data from an XML or TM-XML application and convert that communication into the preferred embodiment's standard markup language. CPA-XML schema 600 includes transactional components 602, case components 604, document components 606, payment components 608, and address book components 610.

The embodiments use a novel, flexible XSD schema that is universal in the aspect of being able to define any field to hold any type of data. This is a significant advantage and more efficient technology than prior XML systems that use only fixed fields within rigid protocol systems. Data mapping can occur within the flexible schema such that a unique definition can be defined or the field mapped to a prior defined standard. Using the flexible approach, maps of can be defined in various style sheets for any number of external data sources that use different XML configurations, providing the present embodiment the ability to receive data from and transmit data to those external applications automatically and efficiently.

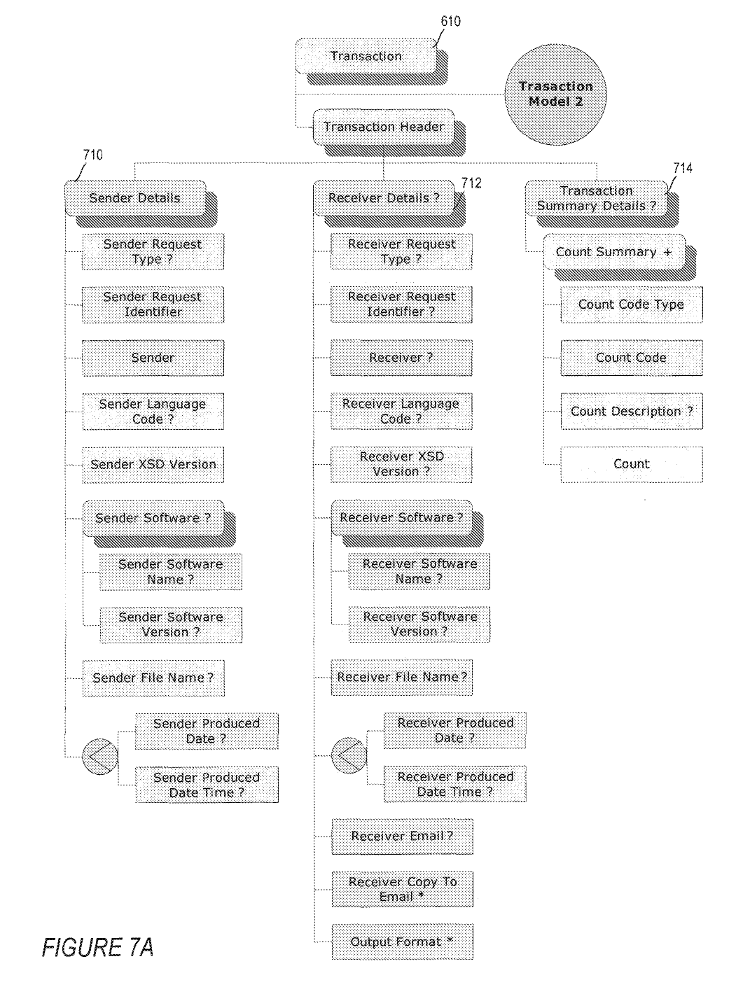

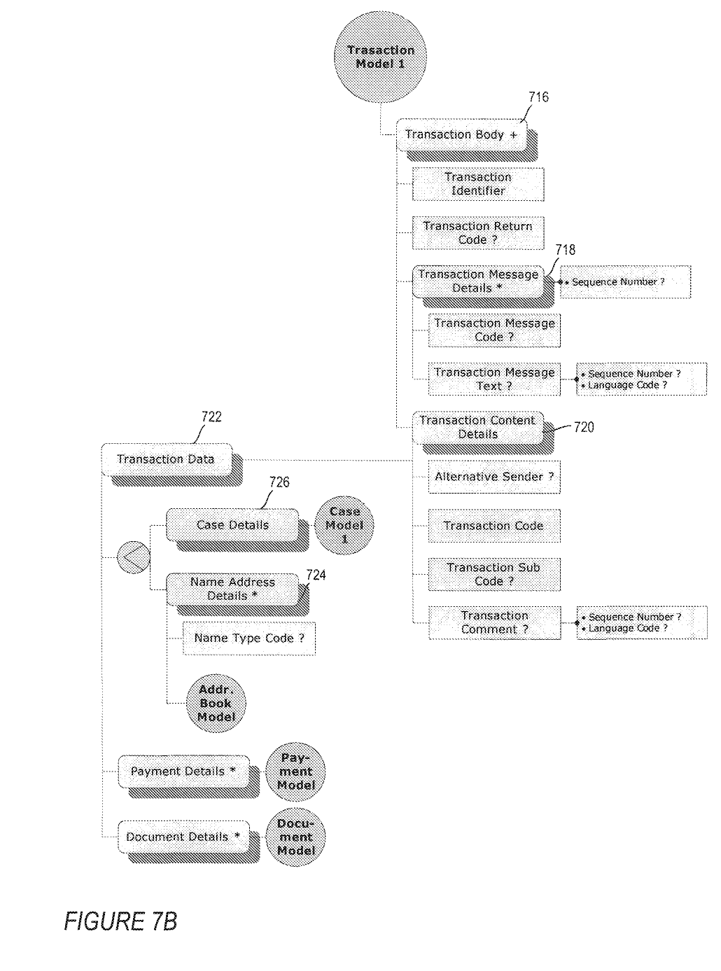

The following table lists components for transaction components 610 for the preferred CPA-XML schema, which are also illustrated in FIG. 7A:

| Element | Description |
|---|---|
| Transaction (root) | Top Level Transaction for all Types of Message |
| Transaction Header | Data concerning the entire transaction |
| Sender Details | Data from the requesting client or sending IP |
| | office, for the entire transaction |
| Receiver Details | Data from the recipient or receiving IP office, for |
| | the entire transaction |
| Transaction | Information summary for the entire transaction |
| Summary Details | |
| Transaction Body | Data concerning message handling and |
| | transaction content. |

The following table lists components for transaction sender details 710 for the preferred CPA-XML schema:

| Element | Description |
|---|---|
| Sender Request | Type of the request |
| Type | |
| Sender Request | Sender identifier for the transaction. A sequential |
| Identifier | number could be used. |
| | Example: “1234” |
| Sender | Name or Code of the producer of the request or |
| | transaction |
| | Example: “ABC” |
| Sender Language | Language code of the header data |
| Code | Example: “en” for English |
| Sender XSD Version | Name and version of the schema |
| | Example: “CPA-XML_V0_4” |
| Sender Software | Detail of the software used to generate the CPA |
| | XML. |
| Sender Software | Name of the software |
| Name | |
| Sender Software | Version of the software |
| Version | |
| Sender File Name | File Name of the entire transaction file |
| | Example: “CPA-XML_20060112_123.xml” |
| Sender Produced | Date of the request or transaction is produced. |
| Date | If this element is used, the Sender Produced Date |
| | Time” can't be defined in the XML. |
| | Example: “2006-01-12” |
| Sender Produced | Date Time of the request or transaction is produced. |
| Date Time | If this element is used, the Sender Produced Date |
| | can't be defined in the XML. |
| | Example: “2006-01-12T09:30:47.0Z” |

The “Sender Request Type” tag for sender details 710 has values of any string but may include data input, data input response, events, initial data export, data export, agent instruction, and agent response. The “Sender” tag for sender details 710 will always be a code representing the producer.

The following table lists components for transaction receiver details 712 for the preferred CPA-XML schema:

| Element | Description |
|---|---|
| Receiver Request | Type of the request for the original request or the |
| Type | transaction. |
| Receiver Request | Receiver identifier for the transaction. |
| Identifier | |
| Receiver | Name or Code of the producer of the original |
| | request or transaction |
| | Example: “ABC” |
| Receiver Language | Language code of the receiver |
| Code | Example: “en” for English |
| Receiver XSD | Name and version of the schema used by the |
| Version | receiver. |
| | Example: “CPA-XML_V0_4” |
| Receiver Software | Detail of the software which was used by the |
| | receiver to generate the original CPA XML. |
| Receiver Software | Name of the software used by the receiver. |
| Name | |
| Receiver Software | Version of the software |
| Version | |
| Receiver File Name | Original File Name from the receiver |
| | Example: “CPA-XML_20060112_123.xml” |
| Receiver Produced | Date of the request or transaction has been |
| Date | produced. |
| | If this element is used, the Receiver Produced Date |
| | Time” can't be defined in the XML. |
| | Example: “2006-01-12” |
| Receiver Produced | Date Time of the request or transaction has been |
| Date Time | produced. |
| | If this element is used, the Receiver Produced Date |
| | can't be defined in the XML. |
| | Example: “2006-01-12T09:30:47.0Z” |
| Receiver Email | Email address of the receiver. Is used when the |
| | XML is to be sent to the receiver via email. |
| Receiver Copy To | List of “copy to” emails requested by the receiver. |
| Email | |
| Output Format | List of output formats requested by the receiver. Is |
| | used when the XML output is to be converted into |
| | additional file formats. |

The following table lists components for transaction summary details 714 for the preferred CPA-XML schema:

| Element | Description |
|---|---|
| Count Summary | Detail of a Count Summary |
| Count Type Code | Type Code of the count |
| Count Code | Code of the count |
| Count Description | Description of the count |
| Count | Number. Value must be greater or equal to 0 |

The following table lists components for transaction body details 716 for the preferred CPA-XML schema, which is also illustrated in FIG. 7B:

| Element | Description | |
|---|---|---|
| Transaction | Sender's identifier for one request or transaction. | |
| Identifier | A sequential number could be used. | |
| | The transaction identifier must be unique across | |
| | the request or transaction. | |
| Transaction | Code returned for the transaction. | |
| Return Code | Indicates the success or failure of the transaction. | |
| Transaction | Data concerning message handling. The original | |
| Message Details | sender should not put any data on this element. It | |
| | concerns general information for the transaction. | |
| | Errors are also reported here. | |
| | Attribute | Description |
| | Sequence Number | Position in sequence |
| | | of the message. |

| | |
|---|---|
| Transaction | Details of the content of the request or the |
| Content Details | transaction |

The following table lists components for transaction message details 718 for the preferred CPA-XML schema:

| Element | Description | |
|---|---|---|
| Transaction | Code of transaction message return | |
| Message Code | | |
| Transaction | Free Text concerning the transaction message | |
| Message Text | Attribute | Description |
| | Sequence Number | Position in sequence of |
| | | the text. |
| | Language Code | Language of the text. |

The following table lists components for transaction content details 720 for the preferred CPA-XML schema:

| Element | Description | |
|---|---|---|
| Alternative Sender | Indicates the site responsible for the data, when it | |
| | is different to the site that sent the data. Is used by | |
| | agents who have offices, and the agent is sending | |
| | data on behalf of their office. | |
| Transaction Code | Code for the type of request or transaction | |
| Transaction Sub | Sub code for the type of request or transaction | |
| Code | | |
| Transaction | Used by sender to give a comment on the | |
| Comment | transaction. | |
| | Attribute | Description |
| | Sequence Number | Position in sequence of |
| | | the text. |
| | Language Code | Language of the text. |

| | |
|---|---|
| Transaction Data | Content of the transaction. Either a Case Details or |
| | Name Address Detail must occur. |

The following table lists components for transaction data details 722 for the preferred CPA-XML schema:

| Element | Description |
|---|---|
| Case Details | Details of a Case request or transaction |
| | See: Case Components |
| Name Address | Details of a Name Address (for update only) |
| Details | See: Name Address Details |
| Payment Details | Data concerning the payment for the transaction |
| | See: Payment Components |
| Document Details | Data concerning the documents for the transaction |
| | See: Document Components |

The following table lists components for transaction name address details 724 for the preferred CPA-XML schema:

| Element | Description |
|---|---|
| Name Type Code | Type of the name |
| Address Book | Details of a Name Address (for update only) |
| | See: Address Book Components |

The following table lists components for transaction case details 726 for the preferred CPA-XML schema:

| Element | Description |
|---|---|
| Case | Top Level Case for all Types of Case |
| Description Details | Descriptions of the Case |
| Identifier Number | List of identifier numbers associated to the Case |
| Details | |
| Event Details | List of events associated to the Case |
| Name Details | List of names associated to the Case |
| Associated Case | List of associated Cases |
| Details | |
| Designated Country | List of designated countries |
| Details | |
| Good And Services | List of goods and services (Trademark) |
| Details | |
| Charge Details | List of charges associated to the Case |
| Patent Term | Data related to the Patent Term Adjustment from |
| Adjustment | the USPTO |

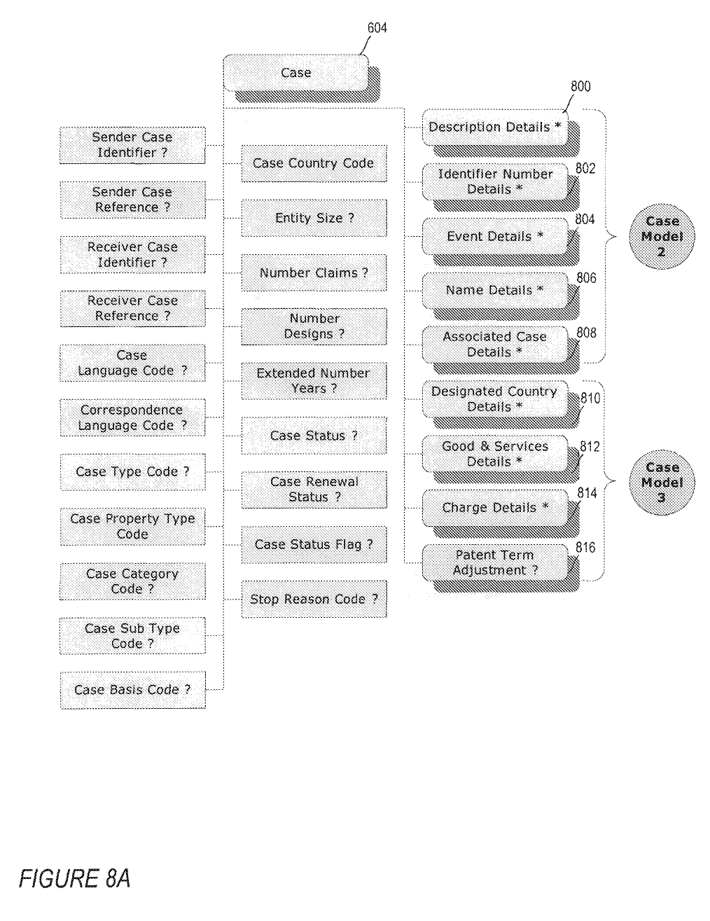

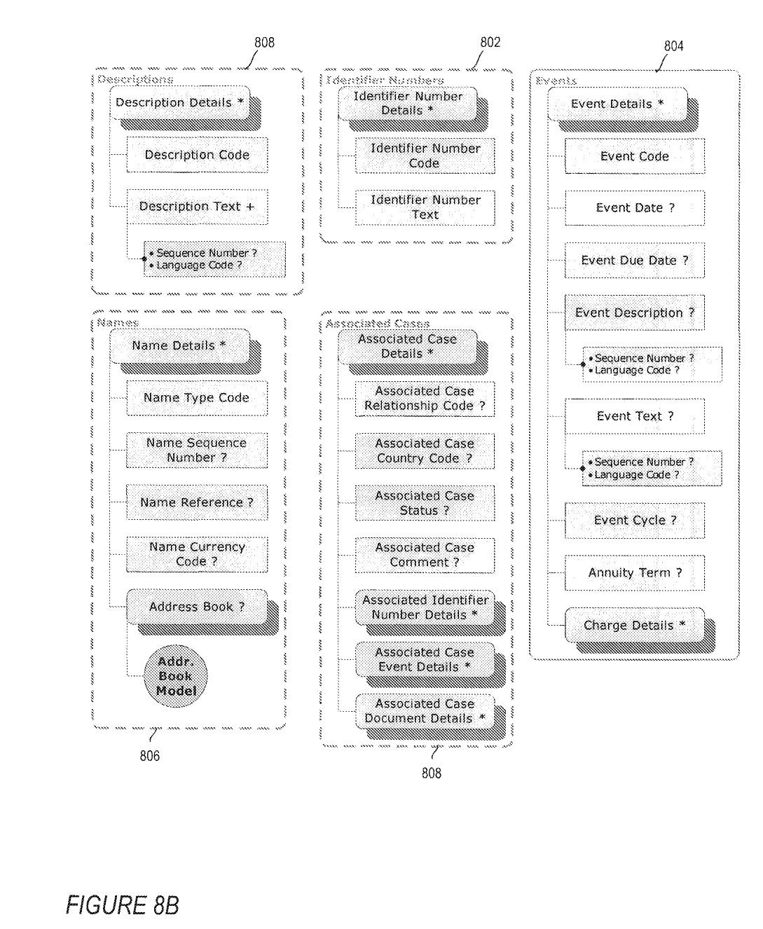

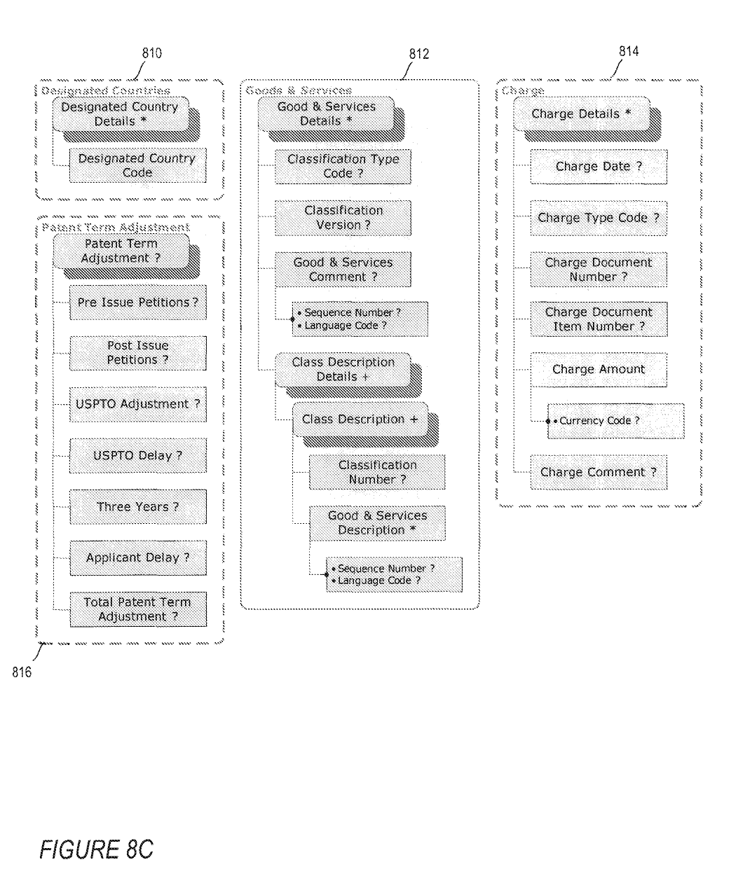

The following table lists components for case components 604 for the preferred CPA-XML schema. Diagrams illustrating the corresponding case components are shown in FIGS. 8A, 8B, and 8C.

| Element | Description |
|---|---|
| Sender Case | Sender's unique identifier for a Case. |
| Identifier | |
| Sender Case | Sender's Case Reference. |
| Reference | |
| Receiver Case | Receiver's unique identifier for a Case. |
| Identifier | |
| Receiver Case | Receiver's Case Reference. |
| Reference | |
| Case Language | Code of (first) language of the Case |
| Code | |
| Correspondence | Language used within correspondence. |
| Language Code | |
| Case Type Code | Type of a Case |
| Case Property Type | Property Type Code of a Case |
| Code | |
| Case Category Code | Category Code of a Case |
| Case Sub Type | Sub Type of a Case |
| Code | |
| Case Basis Code | The basis under which this application is being |
| | made |
| Case Country Code | Country of a Case |
| Entity Size | This act as a flag to show whether the proprietor |
| | qualify for small entity fee reduction in the USA and |
| | Canada |
| Number Claims | Number of claims for the Case |
| Number Designs | Number of Design for the Case |
| Extended Number | Number of years when the renewal is extended |
| Years | (e.g. Supplementary Protection Certificates) |
| Case Status | Status of the Case |
| Case Renewal | This indicates what state the case is up to from a |
| Status | renewal point of view. |
| Case Status Flag | This flag identifies if the case is active or not. |
| Stop Reason Code | The reason code to stop, i.e. a payment |

The following table lists components for case description details 800 for the preferred CPA-XML schema:

| Element | Description |
|---|---|
| Description Code | Code of the Description |
| Description Text | Description |

| Attribute | Description |
|---|---|
| Sequence Number | Position in sequence of |
| | the text. |
| Language Code | Language of the text. |

The following table lists components for case identifier number details 802 for the preferred CPA-XML schema:

| Element | Description |
|---|---|
| Identifier Number | Code of the identifier number |
| Code | |
| Identifier Number | Value for the identifier number |
| Text | |

The following table lists components for case event details 804 for the preferred CPA-XML schema:

| Element | Description | |
|---|---|---|
| Event Code | Code of the event | |
| Event Date | Performed date of the event | |
| Event Due Date | Date the event is due to occur | |
| Event Description | Description of the event | |
| | Attribute | Description |
| | Sequence Number | Position in sequence |
| | | of the text. |
| | Language Code | Language of the text. |
| Event Text | Comment on the event | |
| | Attribute | Description |
| | Sequence Number | Position in sequence |
| | | of the text. |
| | Language Code | Language of the text. |

| | |
|---|---|
| Event Cycle | Sequential number |
| Annuity Term | Annuity or Term number associated with |
| | the Event |
| Event Charge Details | List of charges associated with the Event |
| | See: Charge Details |

The following table lists components for case name details for the preferred CPA-XML schema:

| Element | Description |
|---|---|
| Name Type Code | Type of the name |
| Name Sequence | Position in sequence of the name grouped by name |
| Number | type |
| Name Reference | Reference of the name (i.e. Client's reference) |
| Name Currency | Code of the currency used by the name |
| Code | |
| Address Book | Name and Address |
| | See: Address Book Components |

The following table lists components for associated case details 808 for the preferred CPA-XML schema:

| Element | Description |
|---|---|
| Associated Case | Type of Relationship with the Case |
| Relationship Code | |
| Associated Case | Country code of the associated Case |
| Country Code | |
| Associated Case | Status of the Associated Case |
| Status | |
| Associated Case | Text for comment concerning the associated Case |
| Comment | |
| Associated Case | List of identifier number for the associated Case |
| Identifier Number | See: Identifier Number Details |
| Details | |
| Associated Case | List of events for the associated Case |
| Event Details | See: Event Details |
| Associated Case | Accompanying documents with the associated Case |
| Document Details | See: Document Components |

The following table lists components for case designated country details 810 for the preferred CPA-XML schema:

| Element | Description |
|---|---|
| Designated Country | Designated country code |
| Code | |

The following table lists components for case good and services details 812 for the preferred CPA-XML schema:

| Element | Description | |
|---|---|---|
| Classification Type | Type of classification | |
| Code | | |
| Classification | Version of Classification | |
| Version | | |
| Goods and Services Comment | General statement concerning goods | |
| | and services | |
| | Attribute | Description |
| | Sequence Number | Position in |
| | | sequence of |
| | | the text. |
| | Language Code | Language of the text. |
| Class Description | Details of Goods and Services classes and | |
| Details | descriptions | |
| Classification | Classification description | |
| Description | | |
| Classification | Classification number | |
| Number | | |
| Goods and Services | Description of goods or services within | |
| | the class | |
| Description | Attribute | Description |
| | Sequence Number | Position in |
| | | sequence of |
| | | the text. |
| | Language Code | Language of the |
| | | text. |

The following table lists components for case charge details 814 for the preferred CPA-XML schema:

| Element | Description | |
|---|---|---|
| Charge Date | Date of the charge | |
| Charge Type Code | Type of the charge | |
| Charge Document | Indicates the document number (i.e. Invoice | |
| Number | Number) for the charge | |
| Charge Document | Indicates the document item number (i.e. Invoice | |
| Item Number | Line Number) for the charge | |
| Charge Amount | Amount of the charge | |
| | Attribute | Description |
| | Currency Code | ISO 4217-Alpha Code |
| | | (Three Letter Currency |
| | | Code) |

| | |
|---|---|
| Charge Comment | Comment on the Charge |

The following table lists components for case patent term adjustment details 816 for the preferred CPA-XML schema:

| Element | Description |
|---|---|
| Pre Issue Petitions | The PRE-ISSUE PETITIONS entry reflects |
| | adjustments to the term of the patent resulting from |
| | a request for reconsideration of the patent term |
| | adjustment. |
| Post Issue Petitions | The POST-ISSUE PETITIONS entry reflects |
| | adjustments to the term of the patent for post- |
| | issuance request for reconsideration based upon |
| | the patent being issued on a date other than the |
| | projected date of issue. |
| USPTO Adjustment | The USPTO ADJUSTMENT entry reflects |
| | adjustments to the term of the patent by USPTO |
| | personnel which are not generated by the computer |
| | program. |
| USPTO Delay | The USPTO DELAY entry reflects adjustments of |
| | the patent term due to examination delay other than |
| | delays caused by failure to issue a patent within |
| | three years of the actual filing date of the |
| | application. |
| Three Years | The THREE YEARS entry reflects adjustment to the |
| | term of the patent due to failure to issue the patent |
| | within three years of the actual filing date of the |
| | application in the United States. |
| Applicant Delay | The APPLICANT DELAY entry reflects adjustments |
| | of the patent term due to the Applicant's failure to |
| | engage in reasonable efforts to conclude |
| | prosecution of the application for the cumulative |
| | period in excess of three months. |
| Total Patent Term | The TOTAL PTA entry reflects the total adjustment |
| Adjustment | to the term of the patent. The TOTAL PTA entry is |
| | the summation (excluding any time periods which |
| | overlap) of the addition of the adjustments to the |
| | term of the patent reflected in the PRE-ISSUE |
| | PETITIONS, POST-ISSUE PETITIONS, USPTO |
| | ADJUSTMENTS, USPTO DELAY minus the |
| | APPLICANT DELAY adjustment or zero, whichever |
| | is greater. The cumulative total amount of days |
| | adjustment to the term of the patent is determined |
| | by the computer program. |

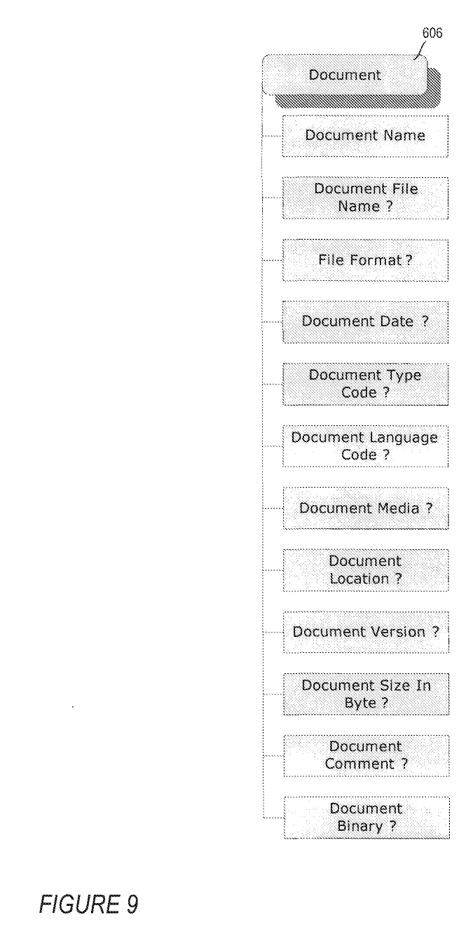

The following table lists components for documents details 606 for the preferred CPA-XML schema. FIG. 9 further illustrates the document tag details of the embodiments.

| Element | Description |
|---|---|
| Document | Detail of accompanying document |
| Document Name | Document name or title |
| Document File Name | Document file name |
| Document File | Document file name extension |
| Format | |
| Document Date | Date of creation of the document |
| Document Type | Type of document |
| Code | |
| Document Language | Code for language used in the document, |
| Code | if different from the Case or Request |
| | Language Code |
| Document Media | Code for document media (electronic, |
| | paper, inside, outside, etc . . .) |
| Document Location | Reference to the location of the document |
| | within the package (zip file) |
| Document Version | Document version |
| | Example: “1.0” |
| Document Size In | Document size in bytes |
| Byte | |
| Document Comment | Text for comment concerning the document |
| Document Binary | Embedded document in binary base 64 format |

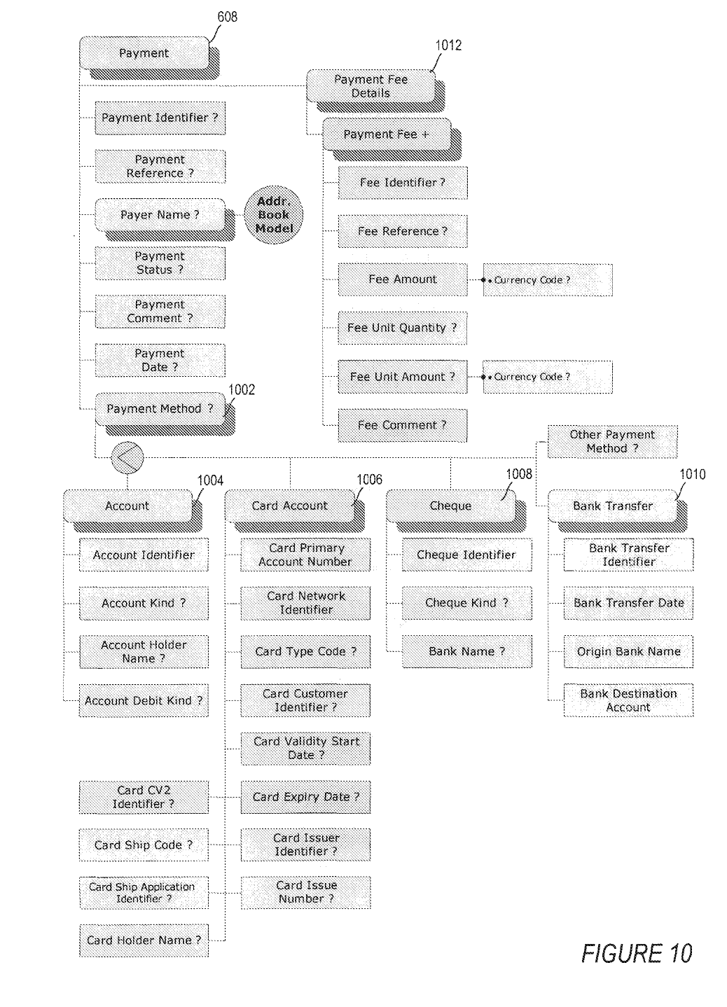

The following table lists components for payment details 608 for the preferred CPA-XML schema. FIG. 10 further illustrates the document tag details of the embodiments.

| Element | Description |
|---|---|
| Payment | Detail of a payment |
| Payment Identifier | Identifier of the payment |
| Payment Reference | Free text reference in addition to the identifier |
| Payer Name | Details concerning the name of the payer. |
| | See: Address Book Components |
| Payment Status | Status of the payments |
| Payment Comment | Free test for additional comment |
| Payment Date | Date of payment |
| Payment Method | Payment method or mode of payment |
| Payment Fee Details | Specification of sub fess and amount |

The following table lists components for payment method details 1002 for the preferred CPA-XML schema:

| Element | Description |
|---|---|
| Account | Payment by drawing the amount from the internal |
| | account at the office |
| Card Account | Payment by credit card/debit card/chip card or |
| | other card |
| Cheque | Payment by cheque |
| Bank Transfer | Payment by bank transfer |
| Other Payment | Element reserved for any other payment method |
| Method | |

The following table lists components for account details 1004 for the preferred CPA-XML schema:

| Element | Description |
|---|---|
| Account Identifier | Account Identifier or Number |
| Account Kind | |
| Account Holder | |
| Name | |
| Account Debit Kind | Kind of debit account |

The following table lists components for card account details 1006 for the preferred CPA-XML schema:

| Element | Description |
|---|---|
| Card Primary | The identifier number of the card, known as the |
| Account Number | PAN—Primary Account Number |
| | Example: “1234 5678 9012 3456” |
| Card Network | Identifier of the organization providing the network |
| Identifier | for the card |
| | Examples: “VISA”, “MasterCard” |
| Card Type Code | The type of card used for payment, such as a debit |
| | card or credit card, according to a controlled list of |
| | card types |
| Card Customer | The customer reference number. This is used to |
| Identifier | enable transmission of customer specific |
| | information with the card |
| Card Validity Start | The date for which the card is valid |
| Date | |
| Card Expiry Date | The date up to which the card is valid |
| Card Issuer Number | Identifies the organization issuing the card, know as |
| | the BIN—Bank Id. No. |
| Card Issue Number | Identifies the issue number, relevant only to |
| | SWITCH cards |
| Card CV2 Identifier | The CV2 identify on the reverse of the card for |
| | added security. The 3/4 digit number located on the |
| | back of the credit/debit card signature strip. |
| Card Chip Code | Distinction between CHIP and MAG STRIP cards |
| Card Chip | Identifies the application (AID) on a Chip card that |
| Application Identifier | provides the information quoted |
| Card Holder Name | Name of the credit card holder |

The following table lists components for cheque details 1008 for the preferred CPA-XML schema:

| Element | Description |
|---|---|
| Cheque Identifier | Identifier of number of the cheque |
| Cheque Kind | Cheque company or system |
| Bank Name | Name of the bank where to cash the cheque |

The following table lists components for bank transfer details 1010 for the preferred CPA-XML schema:

| Element | Description |
|---|---|
| Bank Transfer | Identifier of the bank transfer |
| Identifier | |
| Bank Transfer Date | Date of the bank transfer |
| Origin Bank Name | Name of the bank from where the amount was |
| | transferred |
| Bank Destination | Account number where the amount was transferred |
| Account | to |

The following table lists components for payment fee details 1012 for the preferred CPA-XML schema:

| Element | Description | |
|---|---|---|
| Fee Identifier | Identifier of a fee | |
| Fee Reference | Free text reference to the fee | |
| Fee Amount | The total fee amount | |
| | Attribute | Description |
| | Currency Code | ISO 4217-Alpha Code |
| | | (Three Letter Currency |
| | | Code) |
| Fee Unit Quantity | The quantity of factor the unit amount is multiplied | |
| | by | |
| Fee Unit Amount | The unit amount of a fee | |
| | Attribute | Description |
| | Currency Code | ISO 4217-Alpha Code |
| | | (Three Letter Currency |
| | | Code) |

| | |
|---|---|
| Fee Comment | Free text comment to the fee |

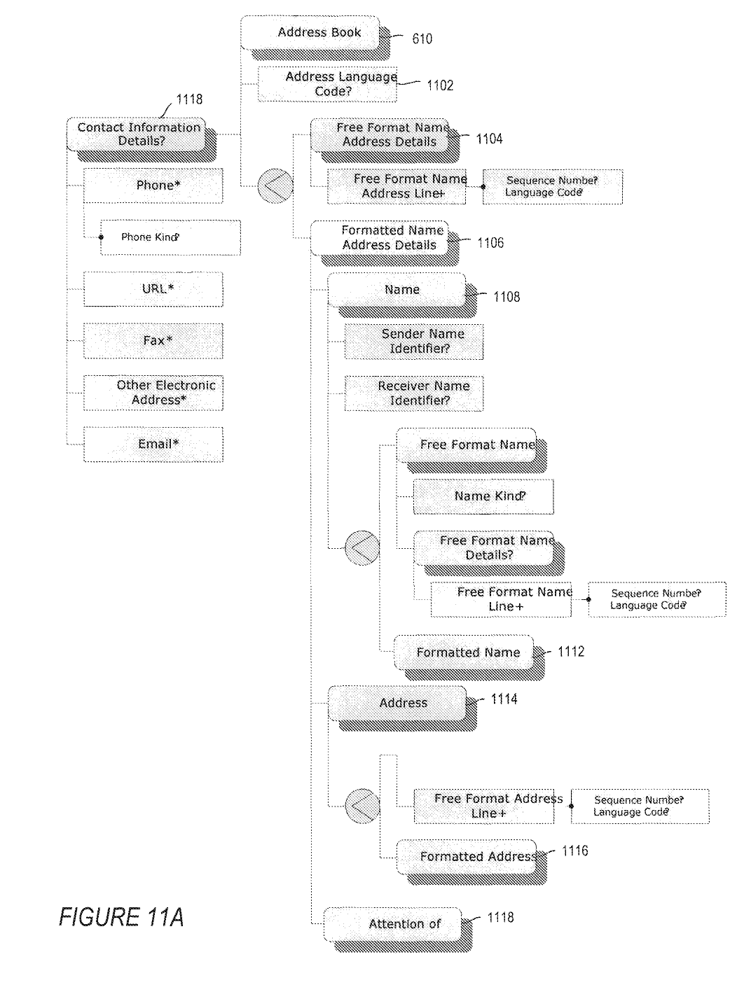

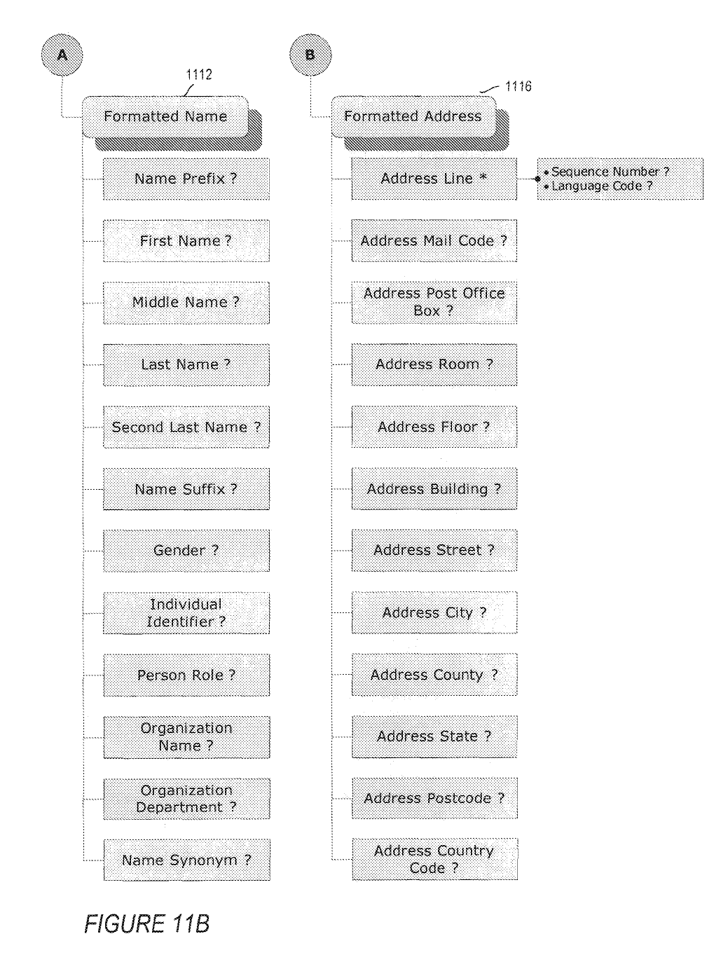

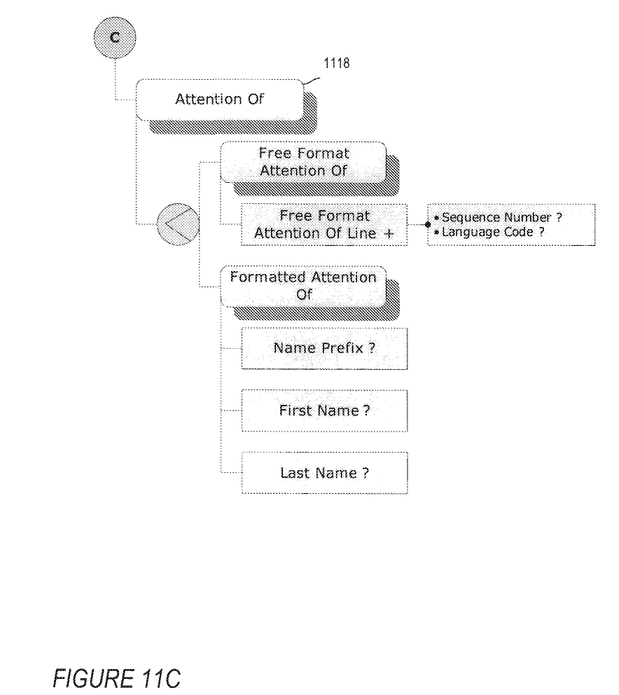

The following table lists components for address book 610 details for the preferred CPA-XML schema. FIGS. 11A, 11B, and 11C further illustrate the document tag details of the embodiments.

| Element | Description |
|---|---|
| Address Book | Name, Address and contact information for |
| | individuals and organizations. |
| | Either a Free Format Name Address Details or |
| | Formatted Name Address Detail must occur. |
| Free Format Name | Name and Address in free format |
| Address Details | |
| Formatted Name | Name and Address in specified format |
| Address Details | |
| Contact Information | Contact information other than name and address |
| Details | |

The following table lists components for address code language 1102 details for the preferred CPA-XML schema:

| Element | Description |
|---|---|
| Address Language | Language used for the address, if different from the |
| Code | Case or Request Language Code. |
| | Example: “en” |

The following table lists components for free format name address details 1104 for the preferred CPA-XML schema:

| Element | Description | |
|---|---|---|
| Free Format Name Address Line | Name or Address in free format | |
| | Attribute | Description |
| | Sequence Number | Position in |
| | | sequence of |
| | | the text. |
| | Language Code | Language of |
| | | the text. |

Note:
The element may be used for a data migration of a new client to a CPASS Product.

The following table lists components for formatted name address details 1106 for the preferred CPA-XML schema:

| Element | Description |
|---|---|
| Name | Name details. |
| | Either a Free Format Name or Formatted Name |
| | must occur. |
| Address | Address Details. |
| | Either a Free Format Address or a Formatted |
| | Address must occur. |
| Attention Of | Attention Of Details. |
| | Either a Free Format Attention Of or a Formatted |
| | Attention Of must occur. |

The following table lists components for name details 1108 for the preferred CPA-XML language.

| Element | Description | |
|---|---|---|
| Sender Name | Sender unique Name identifier (i.e.: name | |
| Identifier | code, name or a key). | |
| Receiver Name | Refer to the unique name identifier from | |
| Identifier | the receiver | |
| Free Format Name | Name in free format | |
| Formatted Name | Formatted name | |
| Name Kind | Code for distinction between natural | |
| | persons and corporations | |
| Free Format Name | Name lines in free format. | |
| Details | | |
| Free Format Name Line | Name line in free format. | |
| | Attribute | Description |
| | Sequence Number | Position in sequence |
| | | of the text. |
| | Language Code | Language of the text. |

| | |
|---|---|
| Formatted Name | |
| (1112) | |
| Name Prefix | Name prefix, title |
| First Name | First or given name(s), initial(s) |
| Middle Name | Middle name |
| Last Name | Last, family, surname |
| Second Last Name | Second last name for person names that |
| | have two surnames |
| Name Suffix | Name suffix |
| Gender | Gender |
| Individual Identifier | Kind of individual identifier |
| Person Role | Role of person within organization or |
| | corporation |
| Organization Name | Organization or corporation name |
| Organization | Department, division, section, etc . . . |
| Department | |
| Name Synonym | Synonym |

The following table lists components for address details 1116 for the preferred CPA-XML schema:

| Element | Description | |
|---|---|---|
| Free Format Address | Address in free format | |
| Free Format Address Line | Address line in free format | |
| | Attribute | Description |
| | Sequence Number | Position in sequence |
| | | of the text. |
| | Language Code | Language of the text. |
| Formatted Address | Address in specified format | |
| Address Line | Address line | |
| | Attribute | Description |
| | Sequence Number | Position in sequence |
| | | of the text. |
| | Language Code | Language of the text. |

| | |
|---|---|
| Address Mail Code | Organizational mail code |
| Address Post Office | Post office Box number |
| Box | |
| Address Room | Address room |
| | Example: “55B” |
| Address Floor | Address floor |
| | Example: “10th” |
| Address Building | Building information in address |
| | Example: “Hoffman building” |
| Address Street | Street |
| Address City | City or Town name |
| Address County | County, parish, department, etc . . . |
| Address State | Region of country e.g. state, province, |
| | etc . . . |
| Address Postcode | Postal code or zip code |
| Address Country | Address Country code |
| Code | |

The following table lists components for attention of details 1118 for the preferred CPA-XML schema:

| Element | Description | |
|---|---|---|
| Free Format | Attention Of in free format | |
| Attention Of | | |
| Free FormatAttention Of Line | Attention Of line in free format | |
| | Attribute | Description |
| | Sequence Number | Position in sequence of |
| | | the text. |
| | Language Code | Language of the text. |

| | |
|---|---|
| Formatted Attention | Attention Of in specified format |
| Of | |
| Name Prefix | Name prefix, title |
| First Name | First or given name(s), initial(s) |
| Last Name | Last, family, surname |

The following table lists components for contact information details 1118 for the preferred CPA-XML schema:

| Element | Description |
|---|---|
| Phone | Phone Number |

| Attribute | Description |
|---|---|
| Phone Kind | Code for discrimination |
| | between wired, mobile |
| | and other kind of |
| | numbers. |
| | Values: |
| | “Fixed” |
| | “Mobile Phone” |
| | “Other” |

| | |
|---|---|
| URL | Universal Resource Locator |
| Fax | Fax Number |
| Email | Email address |
| Other Electronic | Electronic address use for other than email |
| Address | |

It will be appreciated that, although specific embodiments of the invention have been described herein for purposes of illustration, various modifications may be made without departing from the spirit and scope of the invention. In particular, a unique name may be assigned to one of the blocks of data employed in the executed query. Accordingly, the scope of protection of this invention is limited only by the following claims and their equivalents.

1. (canceled)

2. (canceled)

3. A computer-implemented method for providing an intellectual property data transmission using a markup language protocol, comprising:
receiving a data export request for intellectual property data;
receiving the intellectual property data from a database;
formatting the intellectual property data according to a first protocol based on a flexible extensible markup language schema definition (“XSD”);
determining, via a computer processor, if the intellectual property data should be formatted according to a second protocol, and if so, formatting the intellectual property data according to the second protocol; and
transmitting the intellectual property data formatted according to at least one of the first protocol and second protocol.

4. The method of claim 3, wherein the formatting the intellectual property data according to the first protocol comprises applying an XSD style sheet to the received intellectual property data.

5. The method of claim 3, wherein the intellectual property data is formatted into the first protocol before the intellectual property data is formatted into the second protocol.

6. The method of claim 3, wherein the formatting of the intellectual property data according to the second protocol comprises formatting the intellectual property data from the first protocol to the second protocol.

7. The method of claim 3, further comprising:
retrieving a map of an external data source associated with the second protocol; and
automatically formatting the data into the second protocol using the map.

8. The method of claim 3, wherein the second protocol comprises an open protocol standard.

9. The method of claim 3, wherein the XSD comprises at least one payment component associated with the intellectual property data.

10. The method of claim 3, wherein the XSD comprises at least one transactional component associated with the intellectual property data.

11. The method of claim 3, wherein the XSD comprises at least one procurement component associated with the intellectual property data.

12. A computer-implemented method for receiving an intellectual property data transmission according to a markup language protocol, comprising:
receiving intellectual property data, the intellectual property data formatted according to an extensible markup language;
determining, via a computer processor, if the intellectual property data is formatted according to a first protocol based on a flexible extensible markup language schema definition (“XSD”), and
if the received intellectual property data is formatted according to the first protocol, validating at least a portion of the intellectual property data according to the first protocol, and
if the received intellectual property data is formatted according to a second protocol, formatting the intellectual property data according to the first protocol;
parsing the intellectual property data according to the first protocol; and
storing the intellectual property data in a storage memory.

13. The method of claim 12, wherein the formatting the intellectual property data according to the first protocol comprises applying an XSD style sheet to the received intellectual property data.

14. The method of claim 12, further comprising, if the received intellectual property data is formatted according to the second protocol:
retrieving a map associated with the second protocol; and
automatically formatting the data from the second protocol to the first protocol using the map.

15. The method of claim 12, wherein the second protocol comprises an open protocol standard.

16. The method of claim 12, wherein the XSD comprises at least one payment component associated with the intellectual property data.

17. The method of claim 12, wherein the XSD comprises at least one transactional component associated with the intellectual property data.

18. The method of claim 12, wherein the XSD comprises at least one procurement component associated with the intellectual property data.

19. A computer-readable storage medium comprising computer-executable instructions for providing an intellectual property transmission using a markup language protocol, the instructions comprising:
receiving a data export request for intellectual property data;
receiving the intellectual property data from a database;
formatting the intellectual property data according to a first protocol based on a flexible extensible markup language schema definition (“XSD”);
determining if the intellectual property data should be formatted according to a second protocol, and if so, formatting the intellectual property data according to the second protocol; and
transmitting the intellectual property data formatted according to at least one of the first protocol and second protocol.

20. A computer-readable storage medium comprising computer-executable instructions for receiving an intellectual property data transmission according to a markup language protocol, the instructions comprising:
receiving intellectual property data, the intellectual property data formatted according to an extensible markup language;
determining if the intellectual property data is formatted according to a first protocol based on a flexible extensible markup language schema definition (“XSD”), and
if the received intellectual property data is formatted according to the first protocol, validating at least a portion of the intellectual property data according to the first protocol, and
if the received intellectual property data is formatted according to a second protocol, formatting the intellectual property data according to the first protocol;
parsing the intellectual property data according to the first protocol; and
storing the intellectual property data into a storage memory.

21. Apparatus for providing intellectual property data exchange using a markup language protocol, the apparatus comprising:
means for storing intellectual property data;
means for receiving a data export request for intellectual property data;
means for receiving the intellectual property data from a relational database;
means for formatting the intellectual property data according to a first protocol based on a flexible extensible markup language schema definition (“XSD”);
means for determining if the intellectual property data should be formatted according to a second protocol, and if so, formatting the intellectual property data according to the second protocol; and
means for transmitting the intellectual property data formatted according to at least one of the first protocol and second protocol.

22. A system for providing intellectual property data exchange using a markup language protocol, the system comprising:
a storage memory configured to store intellectual property data;
a computer-readable storage memory having computer-executable instructions for:
receiving a data export request for intellectual property data;
receiving the intellectual property data from a relational database;
formatting the intellectual property data according to a first protocol based on a flexible extensible markup language schema definition (“XSD”);
